(19) United States
(12) Patent Application Publication
(10) Pub. No.: US 2024/0140426 A1
(43) Pub. Date: May 2, 2024

(54) FOLLOW MODE IN AUTONOMOUS DRIVING SYSTEM

(71) Applicant: GM GLOBAL TECHNOLOGY OPERATIONS LLC, Detroit, MI (US)

(72) Inventors: Milad Jalaliyazdi, Richmond Hill, MI (US); Reza Zarringhalam, Whitby (CA); Constandi John Shami, Ann Arbor, MI (US); Benjamin L. Williams, Milford, MI (US); Ethan Thomas Dietrich, Oak Park, MI (US); Crystal J. Nassouri, Waterford, MI (US); Michael J. Reinker, Beverly Hills, MI (US)

(73) Assignee: GM GLOBAL TECHNOLOGY OPERATIONS LLC, Detroit, MI (US)

(21) Appl. No.: 18/050,202

(22) Filed: Oct. 27, 2022

(51) Int. Cl. B60W 30/165; B60W 30/18; B60W 50/14

(52) U.S. Cl. CPC B60W 30/165; B60W 30/18163; B60W 50/14; B60W 2050/146; B60W 2540/215; B60W 2552/10; B60W 2554/4041; B60W 2554/4045; B60W 2556/65; B60W 2754/30

(57) ABSTRACT

A driver assistance system in a host vehicle is provided. The driver assistance system is configured to: track a plurality of obstacles in front of the host vehicle; receive host vehicle driver selection of a follow operating mode for the driver assistance system via a human machine interface (HMI); identify a candidate lead vehicle from the plurality of tracked obstacles; provide, via the HMI, a line of sight view in front of the host vehicle that includes the candidate lead vehicle; receive host vehicle driver selection of the candidate lead vehicle as a lead vehicle to follow; adjust a desired trajectory calculated by the driver assistance system to obtain and maintain a desired headway between the lead vehicle and the host vehicle; and generate control signals for vehicle actuators to control the host vehicle to follow the desired trajectory to follow the lead vehicle.

### INTRODUCTION

The technical field generally relates to systems, methods, and apparatuses for providing driver assistance during vehicle operations and more particularly relates to systems, methods, and apparatuses for providing autonomous or semi-autonomous driving assistance during vehicle operations.

Driving assistance features are being implemented in modern automotive vehicles. Features such as route following and lane keeping assistance are under continued development. Further driver assistance improvements can decrease the workload for vehicle operations.

It is therefore desirable for methods, systems, and apparatuses for providing driver assistance improvements. Furthermore, other desirable features and characteristics of the present disclosure will become apparent from the subsequent detailed description and the appended claims, taken in conjunction with the accompanying drawings and the foregoing technical field and background.

The information disclosed in this introduction is only for enhancement of understanding of the background of the present disclosure and therefore it may contain information that does not form the prior art that is already known in this country to a person of ordinary skill in the art.

### SUMMARY

Disclosed herein are vehicles with, methods for, and systems for driving assistance. In one embodiment, a driver assistance system in a host vehicle is provided. The driver assistance system includes a controller that is configured to: track a plurality of obstacles in front of the host vehicle; receive host vehicle driver selection of a follow operating mode for the driver assistance system via a human machine interface (HMI) in the host vehicle, wherein when the driver assistance system is in the follow operating mode the host vehicle is controlled to follow a driver-selected lead vehicle; identify a candidate lead vehicle from the plurality of obstacles tracked by the driver assistance system, wherein the candidate lead vehicle is moving in the same direction as the host vehicle; provide, via the HMI, a line of sight view in front of the host vehicle that includes the candidate lead vehicle; provide, via the HMI, a selectable graphical element for host vehicle driver selection of the candidate lead vehicle as a lead vehicle to follow; receive host vehicle driver selection of the candidate lead vehicle as the lead vehicle to follow; adjust a desired trajectory calculated by the driver assistance system to obtain and maintain a desired headway between the lead vehicle and the host vehicle; and generate control signals for vehicle actuators to control the host vehicle to follow the desired trajectory to follow the lead vehicle.

In one embodiment of the driver assistance system, the controller is further configured to provide, via the HMI, a second selectable graphical element for host vehicle driver selection to cancel operations in the follow operating mode and to cause the driver assistance system to resume an operating mode in which it operated prior to entering the follow operating mode.

In one embodiment of the driver assistance system, the controller is further configured to adjust the desired trajectory to cause the host vehicle to perform an automatic lane change to commence following the lead vehicle and control the host vehicle to perform the automatic lane change based on adjusting the desired trajectory.

In one embodiment of the driver assistance system, the controller is further configured to adjust the desired trajectory to cause the host vehicle to perform an automatic lane change to continue following the lead vehicle and control the host vehicle to perform the automatic lane change based on adjusting the desired trajectory.

In one embodiment of the driver assistance system, the controller is further configured to adjust the desired trajectory to cause the host vehicle to perform a left or right-hand turn to continue following the lead vehicle and control the host vehicle to perform the left or right-hand turn based on adjusting the desired trajectory.

In one embodiment of the driver assistance system, the controller is further configured to adjust the desired trajectory to reduce a longitudinal gap between the lead vehicle and the host vehicle to deter other vehicles from moving into the same lane between the lead vehicle and the host vehicle and control the host vehicle to reduce the longitudinal gap between the lead vehicle and the host vehicle based on adjusting the desired trajectory.

In one embodiment of the driver assistance system, the controller is further configured to monitor obstacle tracking data and determine whether lead vehicle tracking has been lost based on monitoring the obstacle tracking data.

In one embodiment of the driver assistance system, the controller is further configured to notify the host vehicle driver, via the HMI, when lead vehicle tracking has been lost.

In one embodiment of the driver assistance system, the controller is further configured to cause the driver assistance system to resume an operating mode in which it operated prior to entering the follow operating mode.

In one embodiment of the driver assistance system, the controller is further configured to determine if resumption of lead vehicle tracking is possible after lead vehicle tracking had been lost and present the host vehicle driver, via the HMI, with a selectable graphical element for choosing to resume the follow operating mode with a tracked vehicle that has been determined to likely be the lead vehicle.

In one embodiment of the driver assistance system, the controller is further configured to determine if resumption of lead vehicle tracking is possible after lead vehicle tracking had been lost based on a probability of target match, P(r), calculation, wherein the P(r) calculation is a function of the probability that an identified vehicle is the lead vehicle based on: the probability that a vehicle class, P(V), of the identified vehicle matches a vehicle class of the lead vehicle, the probability that a vehicle color, P(C), of the identified vehicle matches a vehicle color of the lead vehicle, the probability that a vehicle shape, P(S), of the identified vehicle matches a vehicle shape of the lead vehicle, the probability that a vehicle license plate, P(L), of the identified vehicle matches a vehicle license plate of the lead vehicle, the probability that a vehicle lane position, P(R), of the identified vehicle matches a vehicle lane position of the lead vehicle, the probability of a vehicle match based on the elapsed time, P(t), between lead vehicle tracking being lost and reacquired, or the probability of vehicle identification match P(id) based on an identification code exchanged via V2V communication.

In one embodiment of the driver assistance system, the controller is further configured to determine if resumption of lead vehicle tracking is possible after lead vehicle tracking had been lost based on a probability of target match, P(r), calculation, wherein

P(r)=w_{V}P(V)+w_{C}P(C)+w_{S}P(S)+w_{L}P(L)+w_{R}P(R)+wₜP(t)+w_{id}P(id)

and weights (w_{X}) are set to match the significance of an attribute.

In one embodiment of the driver assistance system, the controller is further configured to monitor the movements and intents of the lead vehicle by monitoring turn signals, lane changes, or V2V communications and prepare to command the host vehicle to perform a turn or lane change based on monitoring the movements and intents of the lead vehicle.

In another embodiment, a vehicle is provided. The vehicle includes a sensor system, an actuator system, a human machine interface (HMI), and a controller. The controller is configured to: track a plurality of obstacles in front of the host vehicle; receive host vehicle driver selection of a follow operating mode for the driver assistance system via the HMI in the host vehicle, wherein when the driver assistance system is in the follow operating mode the host vehicle is controlled to follow a driver-selected lead vehicle; identify a candidate lead vehicle from the plurality of obstacles tracked by the driver assistance system, wherein the candidate lead vehicle is moving in the same direction as the host vehicle; provide, via the HMI, a line of sight view in front of the host vehicle that includes the candidate lead vehicle; provide, via the HMI, a selectable graphical element for host vehicle driver selection of the candidate lead vehicle as a lead vehicle to follow; receive host vehicle driver selection of the candidate lead vehicle as the lead vehicle to follow; adjust a desired trajectory calculated by the driver assistance system to obtain and maintain a desired headway between the lead vehicle and the host vehicle; and generate control signals for vehicle actuators to control the host vehicle to follow the desired trajectory to follow the lead vehicle.

In one embodiment of the vehicle, the controller is further configured to: adjust the desired trajectory to cause the host vehicle to perform an automatic lane change to commence following the lead vehicle; adjust the desired trajectory to cause the host vehicle to perform an automatic lane change to continue following the lead vehicle; adjust the desired trajectory to cause the host vehicle to perform a left or right-hand turn to continue following the lead vehicle; and/or adjust the desired trajectory to reduce a longitudinal gap between the lead vehicle and the host vehicle to deter other vehicles from moving into the same lane between the lead vehicle and the host vehicle.

In another embodiment, a method in a controller implemented driver assistance system in a host vehicle is provided. The method includes: tracking a plurality of obstacles in front of the host vehicle; receiving host vehicle driver selection of a follow operating mode for the driver assistance system via a human machine interface (HMI) in the host vehicle, wherein when the driver assistance system is in the follow operating mode the host vehicle is controlled to follow a driver-selected lead vehicle; identifying a candidate lead vehicle from the plurality of obstacles tracked by the driver assistance system, wherein the candidate lead vehicle is moving in the same direction as the host vehicle; providing, via the HMI, a line of sight view in front of the host vehicle that includes the candidate lead vehicle; providing, via the HMI, a selectable graphical element for host vehicle driver selection of the candidate lead vehicle as a lead vehicle to follow; receiving host vehicle driver selection of the candidate lead vehicle as the lead vehicle to follow; adjusting a desired trajectory calculated by the driver assistance system to obtain and maintain a desired headway between the lead vehicle and the host vehicle; and generating control signals for vehicle actuators to control the host vehicle to follow the desired trajectory to follow the lead vehicle.

In one embodiment, the method further includes monitoring obstacle tracking data and determining whether lead vehicle tracking has been lost based on monitoring the obstacle tracking data.

In one embodiment, the method further includes notifying the host vehicle driver, via the HMI, when lead vehicle tracking has been lost.

In one embodiment, the method further includes causing the driver assistance system to resume an operating mode in which it operated prior to entering the follow operating mode.

In one embodiment, the method further includes determining if resumption of lead vehicle tracking is possible after lead vehicle tracking had been lost and presenting the host vehicle driver, via the HMI, with a selectable graphical element for choosing to resume the follow operating mode with a tracked vehicle that has been determined to likely be the lead vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a diagram depicting an example vehicle that includes a driver assistance system, in accordance with various embodiments;

FIG. 2 is a functional block diagram illustrating an example driver assistance system, in accordance with various embodiments;

FIG. 3 is a process flow chart depicting an example process for implementing a follow operating mode by a driver assistance system, in accordance with various embodiments;

FIGS. 4A-4F are diagrams depicting example interface screens of an example HMI provided by an example ADS to communicate information to a host vehicle driver, in accordance with various embodiments; and

FIG. 5 is a process flow chart depicting an example process in a controller implemented driver assistance system in a host vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In various embodiments, apparatus, systems, techniques, and articles are disclosed for providing a new operating mode in automated driving, called follow operating mode, which utilizes automatic maneuvering features, such as automatic lane change, and provides for a host vehicle to follow a lead vehicle with reduced host vehicle driver workload. The disclosed apparatus, systems, techniques, and articles provide a host vehicle driver with a human machine interface (HMI) for selecting the lead vehicle, locks in the lead vehicle and follows the lead vehicle for the duration of the trip when safe and feasible. In various embodiments, the disclosed apparatus, systems, techniques, and articles trigger automatic maneuvering when the lead vehicle performs a maneuver, reduce the longitudinal gap with the lead vehicle to reduce the probability of cut-ins while in the follow mode, and re-acquire the lead vehicle based on scene and object properties if lead vehicle tracking has been lost. In various embodiments, once follow mode is initiated, the host vehicle monitors the lead vehicle for lane changes (left/right) and maneuvers at intersections through actor semantics or V2V communication.

In various embodiments, apparatus, systems, techniques, and articles disclosed herein provide an HMI in the vehicle instrument panel to allow a driver to select a vehicle-of-interest to follow in a scene using a touch interface or navigation buttons on a steering wheel. In various embodiments, apparatus, systems, techniques, and articles disclosed herein provide visual clues and confirmations to a vehicle driver. In various embodiments, apparatus, systems, techniques, and articles disclosed herein provide alerts via the HMI to the driver when lead vehicle tracking has been lost and returns to a prior driver assistance operating mode.

In various embodiments, apparatus, systems, techniques, and articles disclosed herein re-acquire the lost lead vehicle based on object, scene, and trip properties, after lead vehicle tracking had been lost. In various embodiments, apparatus, systems, techniques, and articles disclosed herein employ a probabilistic match function to recommend re-acquisition of the lead object-of-interest based on class, shape, color, license plate, relative position, time, and/or identification code exchanged via V2V communication. In various embodiments, after confirmation by the driver, apparatus, systems, techniques, and articles disclosed herein will continue operations in a follow operating mode.

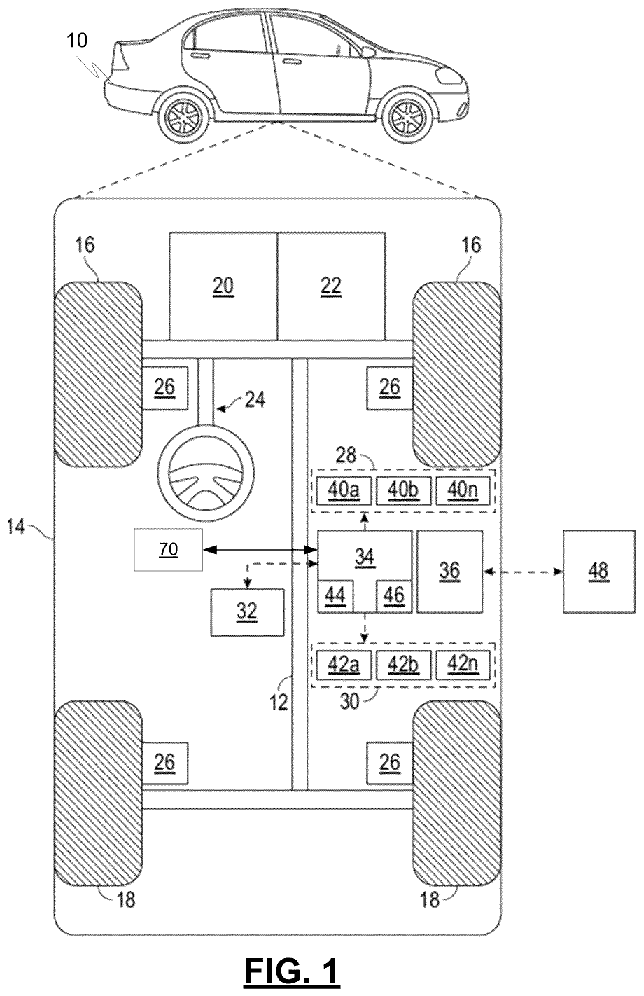

FIG. 1 is a diagram depicting an example vehicle 10 that includes an autonomous driving system 70 for providing hands free driving features for the vehicle. As depicted in FIG. 1, the example vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. The vehicle 10 is depicted in the illustrated embodiment as a passenger car, but other vehicle types, including trucks, sport utility vehicles (SUVs), recreational vehicles (RVs), etc., may also be used. The vehicle 10 is capable of being driven manually, autonomously and/or semi-autonomously.

The vehicle 10 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, and a communication system 36 that is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices.

The sensor system 28 includes one or more sensing devices 40a-40n that sense observable conditions of the exterior environment and/or the interior environment of the autonomous vehicle 10. The sensing devices 40a-40n can include but are not limited to, radars, LiDAR, global positioning systems, optical cameras, thermal cameras, ultrasonic sensors, inertial measurement units, Ultra-Wideband sensors, and/or other sensors. The actuator system 30 includes one or more actuator devices 42a-42n that control one or more vehicle features such as, but not limited to, the propulsion system 20, the transmission system 22, the steering system 24, and the brake system 26.

The data storage device 32 stores data for use in automatically controlling the vehicle 10. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34.

The programming instructions may include one or more separate programs, each of which comprises an ordered listing of executable instructions for implementing logical functions. The one or more instructions of the controller 34, when executed by the processor 44, may configure the vehicle 10 to continuously calculate controllable steering angles for directing the articulated transport system to direct the final trailer in a desired direction and control the articulated transport system to direct the final trailer in the desired direction using the calculated controllable steering angles.

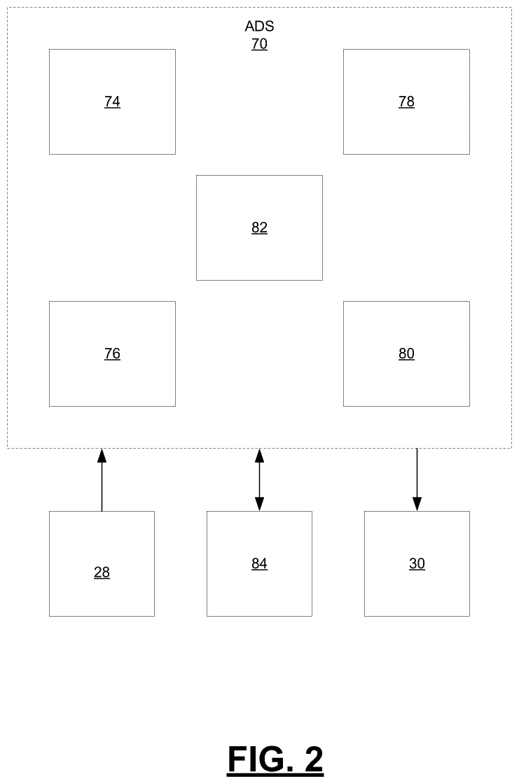

FIG. 2 is a block diagram depicting an example autonomous driving system (ADS) 70 implemented by the controller 34. Suitable software (e.g., programming instructions) and hardware components (e.g., processor 44 and computer-readable storage device 46) of controller 34 are utilized to provide the ADS 70. The example ADS 70 includes a perception system 74, a positioning system 76, a path planning system 78, a vehicle control system 80, and a vehicle following system 82. As can be appreciated, in various embodiments, the software and hardware components of the ADS 70 may be organized into any number of systems (e.g., combined, further partitioned, etc.) as the disclosure is not limited to the present examples.

The example ADS 70 implements semi-autonomous driver assistance features to enable hands-free driving in many operating scenarios. The example ADS 70 can react to permanent traffic control devices, follow internal navigation routes, maintain headway (the average interval of time between vehicles moving in the same direction), follow speed limits, support automatic and on-demand lane change, support left and right-hand turns, support close object avoidance, and support parking in residential driveways, among other things.

The example ADS 70 has multiple modes of operation, including a route following operating mode, an infinite route operating mode, and a vehicle follow operating mode, among others. In the route following operating mode, the example ADS 70 can direct a host vehicle (e.g., vehicle 10) to follow an internal navigation route. In the infinite route operating mode, the example ADS 70 can direct a host vehicle to follow a roadway, such as using a lane centering algorithm. In the vehicle following operating mode, the example ADS 70 can direct a host vehicle to follow a lead vehicle.

The perception system 74 synthesizes and processes acquired sensor data from sensor system 28 and predicts the presence, location, classification, and/or path of objects and features of the environment of the host vehicle 10. In various embodiments, the perception system 74 can incorporate information from multiple sensors from sensor system 28, including but not limited to cameras, radars, and LiDAR, and/or any number of other types of sensors.

The positioning system 76 processes sensor data from sensor system 28 along with other data to determine a position (e.g., a local position relative to a map, an exact position relative to a lane of a road, a vehicle heading, etc.) of the host vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The path planning system 78 processes sensor data from sensor system 28 along with other data to determine a desired path or trajectory for the host vehicle 10 to follow. The path planning system 78 determines a desired trajectory based on the active ADS operating mode employed in the vehicle 10.

The vehicle control system 80 generates control signals for controlling the vehicle 10 according to the determined path. In particular, the vehicle control system 80 generates control signals (e.g., steering control signals, acceleration control signals, braking control signals) for the actuator system 30 to direct the vehicle to follow the desired trajectory determined by the path planning system 78.

The vehicle following system 82 interacts with a Human Machine Interface (HMI) 84 to allow a driver of vehicle 10 to select a vehicle tracked by the perception system 74 as a lead vehicle for the vehicle 10 to follow. The vehicle following system 82 facilitates the ADS 70 transitioning from an internal navigation route operating mode or an infinite route operating mode to a follow operating mode. The vehicle following system 82 provides status information to a host vehicle driver via the HMI 84 regarding implementation of the follow operating mode and provides vehicle tracking data from the perception system 74 for use by the path planning system 78 when determining a desired trajectory.

The HMI 84 is available to the ADS 70 for presenting information to the host vehicle driver and communicates when a host vehicle driver needs to be in control of the host vehicle. The HMI 84 can be incorporated in a vehicle dashboard and can provide a display of the host vehicle environment directly in the driver's line of sight. The HMI 84 can incorporate touchscreen technology for allowing a host vehicle driver to enter selections. The HMI 84 can incorporate vehicle speaker systems to provide aural alerts and messages to the host vehicle driver.

In various embodiments, the controller 34 implements machine learning techniques to assist the functionality of the ADS 70, such as feature detection/classification, obstruction mitigation, route traversal, mapping, sensor integration, ground-truth determination, and the like.

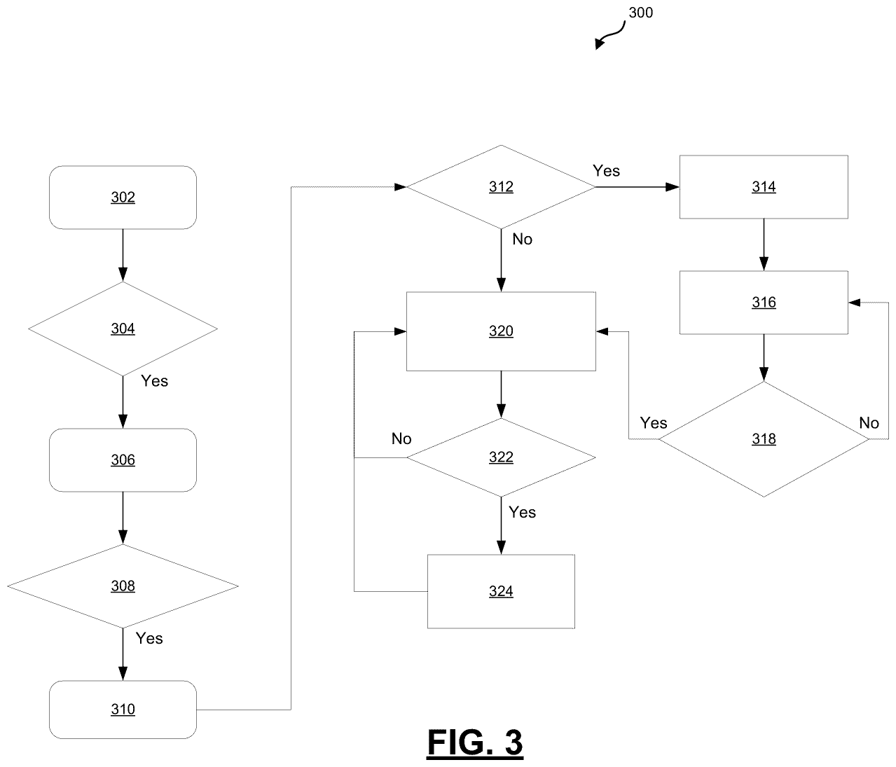

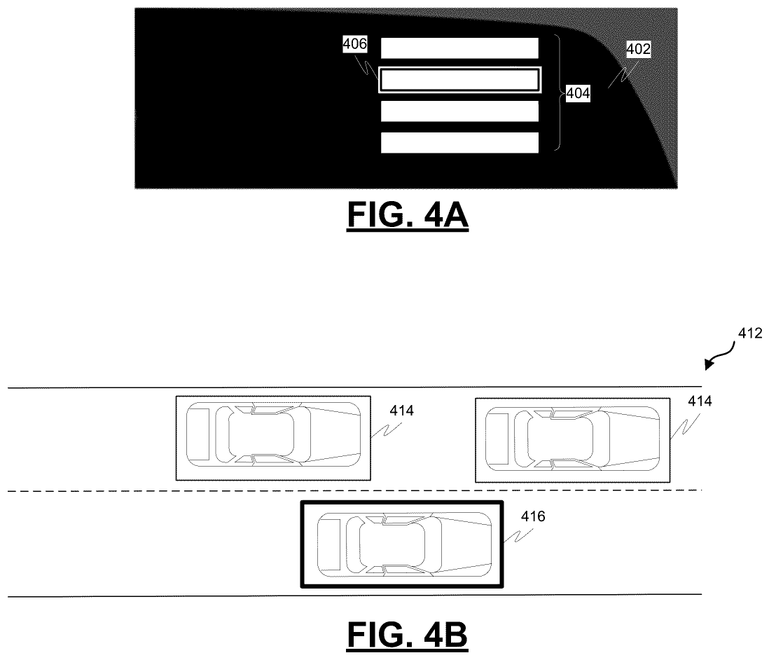

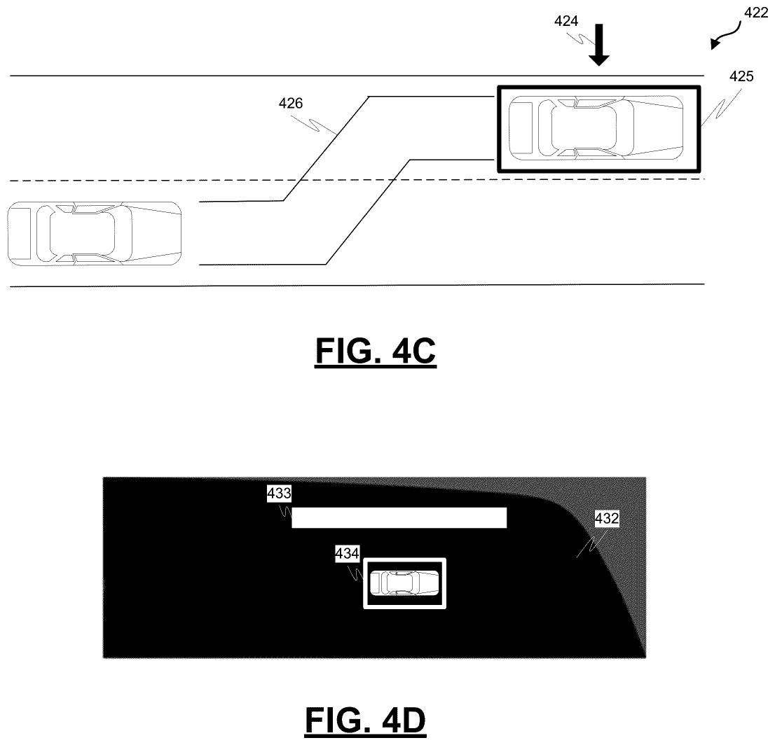

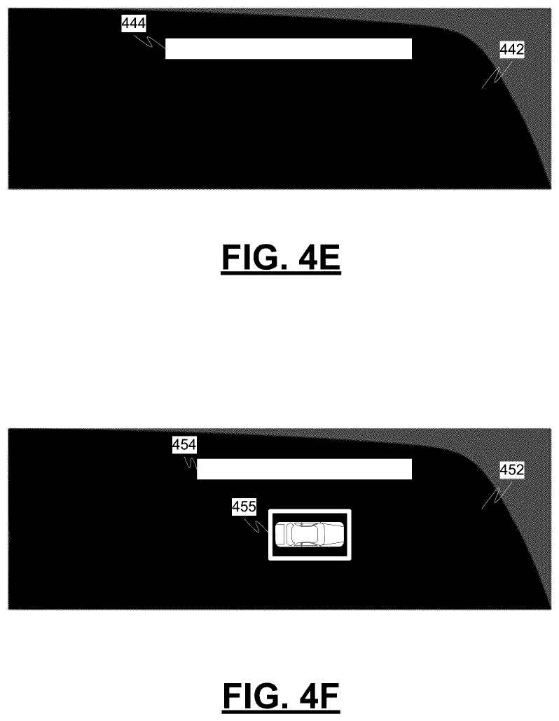

FIG. 3 is a process flow chart depicting an example process 300 for implementing a follow operating mode by a driver assistance system (e.g., ADS 70). The order of operation within process 300 is not limited to the sequential execution as illustrated in the FIG. 3 but may be performed in one or more varying orders as applicable and in accordance with the present disclosure. Process 300 is described in connection with FIGS. 4A-4F, wherein FIGS. 4A-4F depict example interface screens of an example HMI provided by an example ADS to communicate information to a host vehicle driver.

The example process 300 includes, at operation 302, enabling logic to enter the follow operating mode after a compatible automated driver assistance feature is active. In various embodiments, compatible automated driver assistance features include an internal navigation route operating mode or an infinite route operating mode.

In various embodiments, logic to enter the follow operating mode is enabled in response to driver selection of a graphical element indicating a desire to enter the following operating mode. In an example of driver selection of a graphical element indicating a desire to enter the following operating mode, FIG. 4A depicts an example interface screen 402 of an example HMI with a plurality of selectable automated driving feature graphical elements 404 including a Follow Mode graphical element 406 that has been selected via touch selection.

The example process 300 includes, at operation 304, determining if there are one or more candidate lead vehicles in front of the host vehicle. In various embodiments, this includes identifying a subset of objects (one or more) tracked by the driver assistance system (e.g., tracked by a perception system 74) that are moving in the same direction as the host vehicle.

When it is determined that there are one or more candidate lead vehicles in front of the host vehicle (yes at operation 304), the example process 300 includes, at operation 306, providing a graphical element for host vehicle driver selection to select a vehicle to follow. In various embodiments, this includes providing a line of sight view in the HMI with lead vehicle candidates highlighted. In an example, of providing a line of sight view in the HMI with lead vehicle candidates highlighted, FIG. 4B depicts an example interface screen 412 of an example HMI that provides a line of sight view in front of the host vehicle with lead vehicle candidates 414 highlighted (e.g., enclosed in rectangles) and a graphical indication 416 for a host vehicle driver selected lead vehicle.

At operation 308, the example process 300 includes determining if a lead vehicle candidate has been selected by the host vehicle driver and if the host vehicle driver has chosen to activate the follow operating mode. In various embodiments a host vehicle driver may select a lead vehicle from the one or more lead vehicle candidates and activate the follow operating mode after selection of a lead vehicle via touch selections using a touch screen interface of the HMI.

When it is determined that a lead vehicle candidate has been selected and follow operating mode activation has been selected (yes at operation 308), the example process 300 includes, at operation 310, activating the follow operating mode. In an example of activating the follow operating mode, FIG. 4D depicts an example interface screen 432 of an example HMI that provides one or more graphical indications 433, 434 indicating that the follow operating mode is active (e.g., displaying text stating that “Follow Mode Active” and/or box surrounding image representative of tracked lead vehicle).

In various embodiments, activating the follow operating mode includes one or more of adjusting a desired trajectory (e.g., by path planning module 78) to obtain and maintain a desired headway between the lead vehicle and the host vehicle, adjusting a desired trajectory to perform an automatic lane change to follow behind the lead vehicle, adjusting a desired trajectory to perform a left and/or right-hand turn to follow the lead vehicle, and adjusting a desired trajectory to reduce the longitudinal gap between the lead vehicle and the host vehicle to deter other vehicles from moving into the same lane between the lead vehicle and the host vehicle. In various embodiments, to assist with adjusting a desired trajectory, a vehicle following system 82 provides object tracking data from the perception system 74 to the path planning system 78 for use by the path planning system 78 in adjusting a desired trajectory to follow a lead vehicle.

In an example, of performing an automatic lane change to follow behind a lead vehicle, FIG. 4C depicts an example interface screen 422 of an example HMI that provides a line of sight view in front of the host vehicle with one or more graphical indications 424, 425 indicating the lead vehicle and graphical indication 426 indicating that the host vehicle will perform a lane change to follow behind the lead vehicle.

At operation 312, the example process 300 includes monitoring lead vehicle tracking data to determine if lead vehicle tracking has been lost (e.g., lead vehicle is out of sight of camera, radar, LiDAR, etc.). In various embodiments, the vehicle following system 82 determines if lead vehicle tracking has been lost by determining if the perception system 74 is no longer tracking the lead vehicle.

When it is determined that lead vehicle tracking has been lost (yes at operation 312), the example process 300 includes, at operation 314, notifying the host vehicle driver. In various embodiments, the vehicle following system 82 notifies the host vehicle driver that lead vehicle tracking has been lost via the HMI 84. In an example of notifying the host vehicle driver that lead vehicle tracking has been lost, FIG. 4E depicts an example interface screen 442 of an example HMI that provides a graphical indication 444 indicating that lead vehicle tracking has been lost (e.g., displaying text stating that “Target lost—prior driving feature resumes”).

At operation 316, the example process 300 includes resuming the operating mode of the driver assistance system prior to activation of the follow operating mode. In various embodiments, the operating mode of the driver assistance system prior to activation of the follow operating mode includes an internal navigation route operating mode or an infinite route operating mode. In an example of resuming the operating mode of the driver assistance system prior to activation of the follow operating mode, FIG. 4E depicts an example interface screen 442 of an example HMI that provides a graphical indication 444 indicating that lead vehicle tracking has been lost and indicating that a prior operating mode has been reengaged (e.g., displaying text stating that “Target lost—prior driving feature resumes”). In various embodiments, the prior operating mode may be an internal navigation route operating mode. In various embodiments, the prior operating mode may be an infinite route operating mode or lane centering operating mode.

At operation 318, the example process 300 includes determining if the lead vehicle has been reacquired and determining whether the driver confirms that the lead vehicle has been reacquired. In an example of determining whether the driver confirms that the lead vehicle has been reacquired, FIG. 4F depicts an example interface screen 452 of an example HMI that provides one or more selectable graphical indications 454, 455 (e.g., displaying text stating that “Target Re-Acquired—Resume Follow?” and/or box surrounding image representative of re-acquired vehicle) for driver selection indicating the driver's confirmation that the lead vehicle has been reacquired. In various embodiments, the vehicle following system 82 determines if the lead vehicle has been reacquired by determining if the perception system 74 has begun tracking the lead vehicle.

In various embodiments, the vehicle following system 82 determines if the lead vehicle has been reacquired based on a probability of target match, P(r), calculation. In various embodiments, the P(r) calculation is a function of the probability that an identified vehicle is the lead vehicle based on: the probability that a vehicle class, P(V), of the identified vehicle matches a vehicle class of the lead vehicle, the probability that a vehicle color, P(C), of the identified vehicle matches a vehicle color of the lead vehicle, the probability that a vehicle shape, P(S), of the identified vehicle matches a vehicle shape of the lead vehicle, the probability that a vehicle license plate, P(L), of the identified vehicle matches a vehicle license plate of the lead vehicle, the probability that a vehicle lane position, P(R), of the identified vehicle matches a vehicle lane position of the lead vehicle, the probability of a vehicle match based on the elapsed time, P(t), between lead vehicle tracking being lost and reacquired, or the probability of vehicle identification match P(id) based on an identification code exchanged via V2V communication. In various embodiments, P(r) f(P(V), P(C), P(S), P(L), P(R), P(t), P(id)), wherein V represents vehicle class, C represents vehicle color, S represents vehicle shape, L represents vehicle license plate number, R represents vehicle relative lane position, t represents duration between lost/re-acquisition notifications, and id represents a vehicle identification code communicated via V2V communications.

In an embodiment,

P(r)=w_{V}P(V)+w_{C}P(C)+w_{S}P(S)+w_{L}P(L)+w_{R}P(R)+wₜP(t)+w_{id}P(id),

wherein weights (w_{X}) are set to match the significance of an attribute. In an example

$${w}_{L} = \{ \begin{matrix}- ∞ & P ( R ) < 0.1 \\ 0.5 & 0.2 < P ( R ) < 0.99 \\ + ∞ & P ( R ) > 0.99\end{matrix}$$

When it is has not been determined that the lead vehicle has been reacquired (no at operation 318), the example process includes continuing operation 316.

When it is has been determined that the lead vehicle has been reacquired (yes at operation 318), the example process 300 includes, at operation 320, monitoring the movements and intents of the lead vehicle. Also, when it is determined that lead vehicle tracking had not been lost (no at operation 312), the example process 300 includes, at operation 320, monitoring the movements and intents of the lead vehicle. In various embodiments, the intents of the lead vehicle can be monitored via turn signals, lane changes or V2V communications.

At operation 322, the example process 300 includes determining whether the lead vehicle has commenced a lane change, a left turn, or a right turn. In various embodiments, the path planning system 78 determines whether the lead vehicle has commenced a lane change, a left turn, or a right turn.

When it is determined that the lead vehicle has commenced a lane change, a left turn, or a right turn (yes at operation 322), the example process 300 at operation 324 includes commanding an appropriate automated maneuver to continue following the lead vehicle. In various embodiments a path planning system can adjust a desired trajectory to accommodate an appropriate automated maneuver to continue following the lead vehicle, and the vehicle control system 80 can generate control signals to control the actuator system 30 to engage in an appropriate automated maneuver to continue following the lead vehicle.

After commanding an appropriate automated maneuver to continue following the lead vehicle at operation 324 or when it is determined that the lead vehicle has not commenced a lane change, a left turn, or a right turn (no at operation 322), the example process continues, at operation 320, monitoring the movements and intents of the lead vehicle.

In various embodiments, the vehicle following system 82 is configured to interact with the HMI 84 to allow a host vehicle driver to select a vehicle tracked by the perception system 74 as a lead vehicle for the host vehicle to follow and to initiate a driver assistance system follow operating mode from an internal navigation route operating mode or an infinite route operating mode

In various embodiments, the vehicle following system 82 is configured to facilitate the ADS 70 transitioning an operating mode from an internal navigation route operating mode or an infinite route operating mode to a follow operating mode.

In various embodiments, the vehicle following system 82 is configured to provide tracking data from the perception system 74 for use by the path planning system 78 when determining a desired trajectory. In various embodiments, the vehicle following system 82 is configured to provide object tracking data from the perception system 74 to the path planning system 78 for use by the path planning system 78 in adjusting a desired trajectory to follow a lead vehicle.

In various embodiments, the vehicle following system 82 is configured to provide status information to a host vehicle driver via the HMI 84 regarding implementation of the follow operating mode. In various embodiments, the vehicle following system 82 is configured to optionally provide a view of what the ADS sees via the HMI 84. In various embodiments, the vehicle following system 82 is configured to notify the host vehicle driver that lead vehicle tracking has been lost via the HMI 84. In various embodiments, the vehicle following system 82 is configured to notify the host vehicle driver that resumption of lead vehicle tracking is possible after lead vehicle tracking had been lost because the lead vehicle had been reacquired and accept driver selection of the option to resume following lead vehicle via the HMI 84.

In various embodiments, the vehicle following system 82 is configured to determine if lead vehicle tracking has been lost by determining if the perception system 74 is no longer tracking the lead vehicle. In various embodiments, the vehicle following system 82 is configured to determine if the lead vehicle has been reacquired by determining if the perception system 74 has begun tracking the lead vehicle. In various embodiments, the vehicle following system 82 is configured to determine if the lead vehicle has been reacquired based on a probability of target match, P(r), calculation.

In various embodiments, the vehicle following system 82 receives, from the perception system 74, data regarding a plurality of candidate vehicles traveling ahead of the host vehicle and in the same direction of travel as the host vehicle from which a lead vehicle to follow can be chosen, causes an HMI to display the candidate vehicles to the host vehicle driver, receives host vehicle driver selection of a lead vehicle from the candidate vehicles via the HMI, and instructs the path planning system 78 to adjust a desired trajectory of the host vehicle to follow the selected lead vehicle, wherein the vehicle control system 80 generates control signals for controlling the vehicle 10 according to the adjusted desired path.

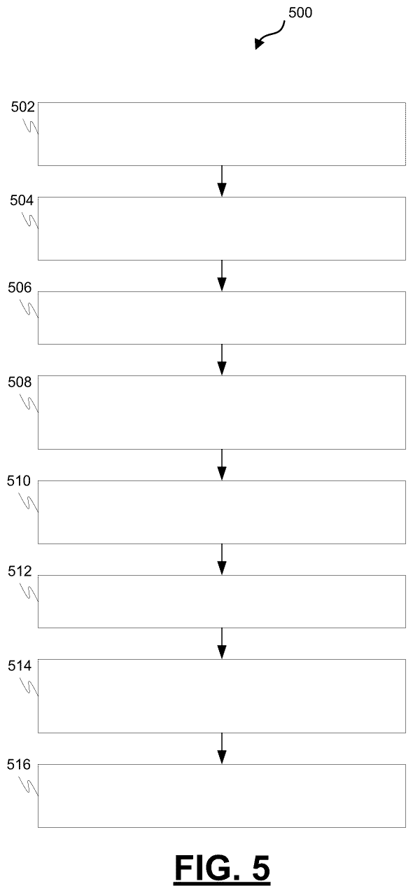

FIG. 5 is a process flow chart depicting an example process 500 in a controller implemented driver assistance system in a host vehicle. The order of operation within process 500 is not limited to the sequential execution as illustrated in the FIG. 5 but may be performed in one or more varying orders as applicable and in accordance with the present disclosure.

At operation 502, the example process 500 includes tracking a plurality of obstacles in front of the host vehicle.

At operation 504, the example process 500 includes receiving host vehicle driver selection of a follow operating mode for the driver assistance system via a human machine interface (HMI) in the host vehicle.

At operation 506, the example process 500 includes identifying a candidate lead vehicle from the plurality of obstacles tracked by the driver assistance system. The candidate lead vehicle is moving in the same direction as the host vehicle.

At operation 508, the example process 500 includes providing, via the HMI, a line of sight view in front of the host vehicle that includes the candidate lead vehicle.

At operation 510, the example process 500 includes providing, via the HMI, a selectable graphical element for host vehicle driver selection of the candidate lead vehicle as a lead vehicle to follow.

At operation 512, the example process 500 includes receiving host vehicle driver selection of the candidate lead vehicle as the lead vehicle to follow.

At operation 514, the example process 500 includes adjusting a desired trajectory calculated by the driver assistance system to obtain and maintain a desired headway between the lead vehicle and the host vehicle.

At operation 516, the example process 500 includes generating control signals for vehicle actuators to control the host vehicle to follow the desired trajectory to follow the lead vehicle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A driver assistance system in a host vehicle, the driver assistance system comprising a controller, the controller configured to:
track a plurality of obstacles in front of the host vehicle;
receive host vehicle driver selection of a follow operating mode for the driver assistance system via a human machine interface (HMI) in the host vehicle, wherein when the driver assistance system is in the follow operating mode the host vehicle is controlled to follow a driver-selected lead vehicle;
identify a candidate lead vehicle from the plurality of obstacles tracked by the driver assistance system, wherein the candidate lead vehicle is moving in the same direction as the host vehicle;
provide, via the HMI, a line of sight view in front of the host vehicle that includes the candidate lead vehicle;
provide, via the HMI, a selectable graphical element for host vehicle driver selection of the candidate lead vehicle as a lead vehicle to follow;
receive host vehicle driver selection of the candidate lead vehicle as the lead vehicle to follow;
adjust a desired trajectory calculated by the driver assistance system to obtain and maintain a desired headway between the lead vehicle and the host vehicle; and
generate control signals for vehicle actuators to control the host vehicle to follow the desired trajectory to follow the lead vehicle.

2. The driver assistance system of claim 1, wherein the controller is further configured to provide, via the HMI, a second selectable graphical element for host vehicle driver selection to cancel operations in the follow operating mode and to cause the driver assistance system to resume an operating mode in which it operated prior to entering the follow operating mode.

3. The driver assistance system of claim 1, wherein the controller is further configured to:
adjust the desired trajectory to cause the host vehicle to perform an automatic lane change to commence or continue following the lead vehicle; and
control the host vehicle to perform the automatic lane change based on adjusting the desired trajectory.

4. The driver assistance system of claim 1, wherein the controller is further configured to:
adjust the desired trajectory to cause the host vehicle to perform a left or right-hand turn to continue following the lead vehicle; and
control the host vehicle to perform the left or right-hand turn based on adjusting the desired trajectory.

5. The driver assistance system of claim 1, wherein the controller is further configured to:
adjust the desired trajectory to reduce a longitudinal gap between the lead vehicle and the host vehicle to deter other vehicles from moving into the same lane between the lead vehicle and the host vehicle; and
control the host vehicle to reduce the longitudinal gap between the lead vehicle and the host vehicle based on adjusting the desired trajectory.

6. The driver assistance system of claim 1, wherein the controller is further configured to:
monitor obstacle tracking data; and
determine whether lead vehicle tracking has been lost based on monitoring the obstacle tracking data.

7. The driver assistance system of claim 6, wherein the controller is further configured to notify the host vehicle driver, via the HMI, when lead vehicle tracking has been lost.

8. The driver assistance system of claim 7, wherein the controller is further configured to cause the driver assistance system to resume an operating mode in which it operated prior to entering the follow operating mode.

9. The driver assistance system of claim 8, wherein the controller is further configured to determine if resumption of lead vehicle tracking is possible after lead vehicle tracking had been lost and present the host vehicle driver, via the HMI, with a selectable graphical element for choosing to resume the follow operating mode with a tracked vehicle that has been determined to likely be the lead vehicle.

10. The driver assistance system of claim 8, wherein the controller is further configured to determine if resumption of lead vehicle tracking is possible after lead vehicle tracking had been lost based on a probability of target match, P(r), calculation, wherein the P(r) calculation is a function of the probability that an identified vehicle is the lead vehicle.

11. The driver assistance system of claim 8, wherein the controller is further configured to determine if resumption of lead vehicle tracking is possible after lead vehicle tracking had been lost based on a probability of target match, P(r), calculation, wherein the P(r) calculation is a function of the probability that an identified vehicle is the lead vehicle based on: the probability that a vehicle class, P(V), of the identified vehicle matches a vehicle class of the lead vehicle, the probability that a vehicle color, P(C), of the identified vehicle matches a vehicle color of the lead vehicle, the probability that a vehicle shape, P(S), of the identified vehicle matches a vehicle shape of the lead vehicle, the probability that a vehicle license plate, P(L), of the identified vehicle matches a vehicle license plate of the lead vehicle, the probability that a vehicle lane position, P(R), of the identified vehicle matches a vehicle lane position of the lead vehicle, or the probability of a vehicle match based on elapsed time, P(t), between lead vehicle tracking being lost and reacquired.

12. The driver assistance system of claim 11, wherein the controller is further configured to determine if resumption of lead vehicle tracking is possible after lead vehicle tracking had been lost based on a probability of target match, P(r), calculation, wherein
P(r)=w_{V}P(V)+w_{C}P(C)+w_{S}P(S)+w_{L}P(L)+w_{R}P(R)+wₜP(t)
and weights (w_{X}) are set to match the significance of an attribute.

13. The driver assistance system of claim 1, wherein the controller is further configured to monitor the movements and intents of the lead vehicle by monitoring turn signals, lane changes, or V2V communications and prepare to command the host vehicle to perform a turn or lane change based on monitoring movements and intents of the lead vehicle.

14. A host vehicle comprising:
a sensor system;
an actuator system;
a human machine interface (HMI); and
a controller for implementing a driver assistance system, the controller configured to:
track a plurality of obstacles in front of the host vehicle;
receive host vehicle driver selection of a follow operating mode for the driver assistance system via the HMI, wherein when the driver assistance system is in the follow operating mode the host vehicle is controlled to follow a driver-selected lead vehicle;
identify a candidate lead vehicle from the plurality of obstacles tracked by the driver assistance system, wherein the candidate lead vehicle is moving in the same direction as the host vehicle;
provide, via the HMI, a line of sight view in front of the host vehicle that includes the candidate lead vehicle;
provide, via the HMI, a selectable graphical element for host vehicle driver selection of the candidate lead vehicle as a lead vehicle to follow;
receive host vehicle driver selection of the candidate lead vehicle as the lead vehicle to follow;
adjust a desired trajectory calculated by the driver assistance system to obtain and maintain a desired headway between the lead vehicle and the host vehicle; and
generate control signals for vehicle actuators to control the host vehicle to follow the desired trajectory to follow the lead vehicle.

15. The vehicle of claim 14, wherein the controller is further configured to:
adjust the desired trajectory to cause the host vehicle to perform an automatic lane change to commence following the lead vehicle;
adjust the desired trajectory to cause the host vehicle to perform an automatic lane change to continue following the lead vehicle;
adjust the desired trajectory to cause the host vehicle to perform a left or right-hand turn to continue following the lead vehicle; and
adjust the desired trajectory to reduce a longitudinal gap between the lead vehicle and the host vehicle to deter other vehicles from moving into the same lane between the lead vehicle and the host vehicle.

16. A method in a controller implemented driver assistance system in a host vehicle, the method comprising:
tracking a plurality of obstacles in front of the host vehicle;
receiving host vehicle driver selection of a follow operating mode for the driver assistance system via a human machine interface (HMI) in the host vehicle, wherein when the driver assistance system is in the follow operating mode the host vehicle is controlled to follow a driver-selected lead vehicle;
identifying a candidate lead vehicle from the plurality of obstacles tracked by the driver assistance system, wherein the candidate lead vehicle is moving in the same direction as the host vehicle;
providing, via the HMI, a line of sight view in front of the host vehicle that includes the candidate lead vehicle;
providing, via the HMI, a selectable graphical element for host vehicle driver selection of the candidate lead vehicle as a lead vehicle to follow;
receiving host vehicle driver selection of the candidate lead vehicle as the lead vehicle to follow;
adjusting a desired trajectory calculated by the driver assistance system to obtain and maintain a desired headway between the lead vehicle and the host vehicle; and
generating control signals for vehicle actuators to control the host vehicle to follow the desired trajectory to follow the lead vehicle.

17. The method of claim 16, further comprising:
monitoring obstacle tracking data; and
determining whether lead vehicle tracking has been lost based on monitoring the obstacle tracking data.

18. The method of claim 17, further comprising notifying the host vehicle driver, via the HMI, when lead vehicle tracking has been lost.

19. The method of claim 18, further comprising causing the driver assistance system to resume an operating mode in which it operated prior to entering the follow operating mode.

20. The method of claim 19, further comprising determining if resumption of lead vehicle tracking is possible after lead vehicle tracking had been lost and presenting the host vehicle driver, via the HMI, with a selectable graphical element for choosing to resume the follow operating mode with a tracked vehicle that has been determined to likely be the lead vehicle.
